(19) United States
(12) Patent Application Publication
(10) Pub. No.: US 2010/0203922 A1
(43) Pub. Date: Aug. 12, 2010

(54) Time Division Duplex Front End Module

(76) Inventors: Thomas A. Knecht, Dundee, IL (US); Glen O. Reeser, Palatine, IL (US)

Correspondence Address: DANIEL J. DENEUFBOURG;CTS CORPORATION, 171 COVINGTON DRIVE, BLOOMINGDALE, IL, 60108, US

(21) Appl. No.: 12/701,681

(22) Filed: Feb. 8, 2010

Related U.S. Application Data
(60) Provisional application No. 61/207,287, filed on Feb. 10, 2009.

(51) Int. Cl. H04B 1/38; H04W 88/02

(52) U.S. Cl. 455/561

(57) ABSTRACT

A front end module for use in a wireless base station such as a picocell includes a housing defining a cavity for a substrate. A first section on the substrate defines a signal transmit path and includes at least the following discrete electronic components: a bandpass filter, a power amplifier, and a coupler. A second section on the substrate defines a signal receive path and includes at least the following discrete electronic components: a bandpass filter and a low-noise amplifier. A switch on the substrate interconnects the first and second sections to an antenna terminal and a wall in the housing extends through a slot in the substrate to isolate the components in the first and second sections. Terminals extend through an exterior wall of the housing and into contact with the substrate.

### CROSS-REFERENCE TO RELATED APPLICATION

This application claims the benefit of the filing date and disclosure of U.S. Provisional Application Ser. No. 61/207,287 filed on Feb. 10, 2009 which is explicitly incorporated herein by reference as are all references cited therein.

### FIELD OF THE INVENTION

The invention relates to a module and, more particularly, to a time division duplex radio frequency (RF) module adapted for use on the front end of a cellular base station such as, for example, a WiMax wireless picocell communication base station.

### BACKGROUND OF THE INVENTION

There are currently four types of cellular/wireless communication base stations or systems in use today for the transmission and reception of LTE, UMTS, and WiMax based cellular/wireless communication signals, i.e., macrocells, microcells, picocells, and femtocells. Macrocells, which today sit atop cellular/wireless towers, deliver at approximately 100 watts. The coverage of macrocells is in miles. Microcells, which are smaller in size than macrocells, are adapted to sit atop telephone poles, for example, and the coverage is in blocks. Microcells generate approximately 20 watts. A smaller yet microcell delivers about 5 watts of power. Picocells are base stations approximately 8″×18″ in size, are adapted for deployment inside buildings such as shopping malls, office buildings or the like, and generate about 0.25 to 1 watts of power. The coverage of a picocell is about 50 yards. Femtocells generate about 0.10 watts of power and are used in the home.

Picocells and microcells in use today typically include a “motherboard” upon which various electrical components have been individually mounted by the customer. A front end portion of the motherboard (i.e., the RF transceiver section thereof located roughly between the picocell antenna and mixers thereof) is currently referred to in the art as the “front end,” i.e., a portion of the femtocell, picocell, or microcell on which all the radio frequency control electrical components such as, for example, the filters, amplifiers, couplers, inductors and the like have been individually mounted and interconnected.

While the configuration and structure of the current motherboards has proven satisfactory for most applications, certain disadvantages include performance, the costs associated with a customer's placement of individual RF components during assembly, and the space which such RF components occupy.

There thus remains the need for increased RF component performance and a reduction in cost of microcells and picocells. The present invention provides a compact front end RF component module particularly adapted and structured for the transmission and reception of WiMax signals.

### SUMMARY OF THE INVENTION

The present invention relates generally to an electronic assembly in the form of a radio frequency (RF) module adapted for use on the front end of a wireless base station such as a picocell base station.

In one embodiment, the electronic assembly or module comprises a transmitter circuit or section which is adapted to receive a transmit input signal and generate a transmit output signal and includes at least the following discrete electronic components direct surface mounted on a substrate adapted for mounting in the front end of a cell's motherboard: a first bandpass filter in communication with a power amplifier; a first coupler in communication with the power amplifier; and a switch in communication with the coupler. In one embodiment, the transmitter circuit additionally includes a driver amplifier between the first bandpass filter and the power amplifier, an isolator between the power amplifier and the coupler, and a low pass filter between the coupler and the switch.

The electronic assembly also comprises a receiver circuit which is adapted to receive a receive input signal and generate a receive output signal and includes at least the following discrete electronic components also direct surface mounted on the substrate: a second bandpass filter in communication with the switch; and a low-noise amplifier amplifier in communication with the second bandpass filter. In one embodiment, the receiver circuit also includes a second low pass filter in communication with the low-noise amplifier, and a third bandpass filter in communication with the second low pass filter.

In one embodiment, the substrate defines a slot and a bridge which separates the transmitter and receiver sections and the substrate is mounted in the cavity of a housing including an interior wall which protrudes through the slot in the substrate to isolate the transmitter and receiver sections in the housing. A plurality of terminals extend into the housing through a housing peripheral wall and into contact with the substrate.

Other advantages and features of the present invention will be more readily apparent from the following detailed description of the preferred embodiment of the invention, the accompanying drawings, and the appended claims.

### BRIEF DESCRIPTION OF THE DRAWINGS

These and other features of the invention can best be understood by the following description of the accompanying FIGURES as follows:

FIG. 1 is a simplified block diagram of one embodiment of the substrate/board assembly of the time division duplex front end module in accordance with the present invention;

FIG. 2 is a simplified top plan view of one structural embodiment of the time division duplex front end module in accordance with the present invention with the cover removed and substrate/board assembly of FIG. 1 seated therein; and

FIG. 3 is a simplified block diagram of another embodiment of the substrate/board assembly of the time division duplex front end module in accordance with the present invention.

### DETAILED DESCRIPTION OF THE EMBODIMENTS

While this invention is susceptible to embodiments in many different forms, this specification and the accompanying FIGURES disclose only two embodiments as examples of the module of the present invention which is adapted for use in a picocell base station. The invention is not intended, however, to be limited to the embodiments so described and extends, for example, to other types of base stations as well.

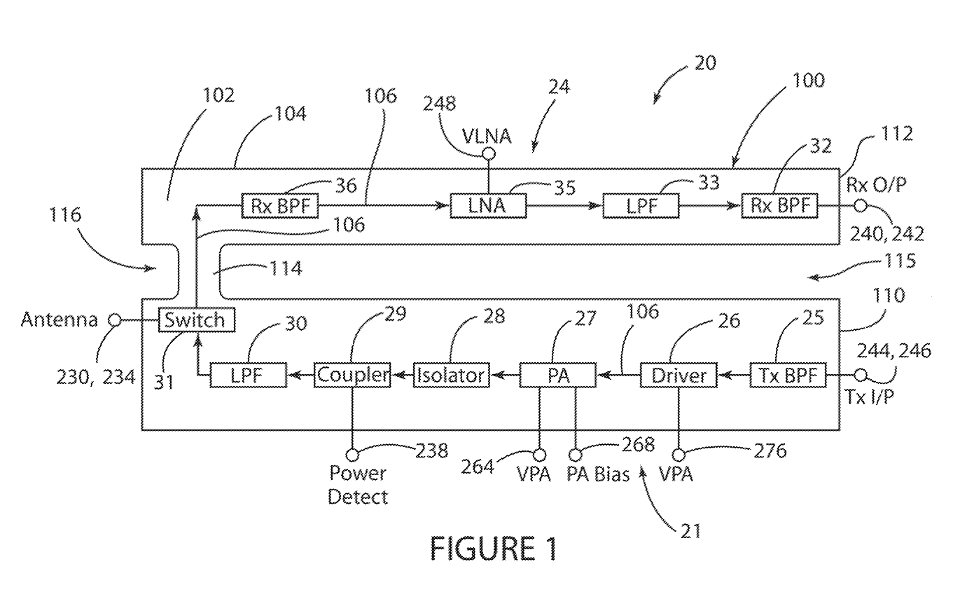

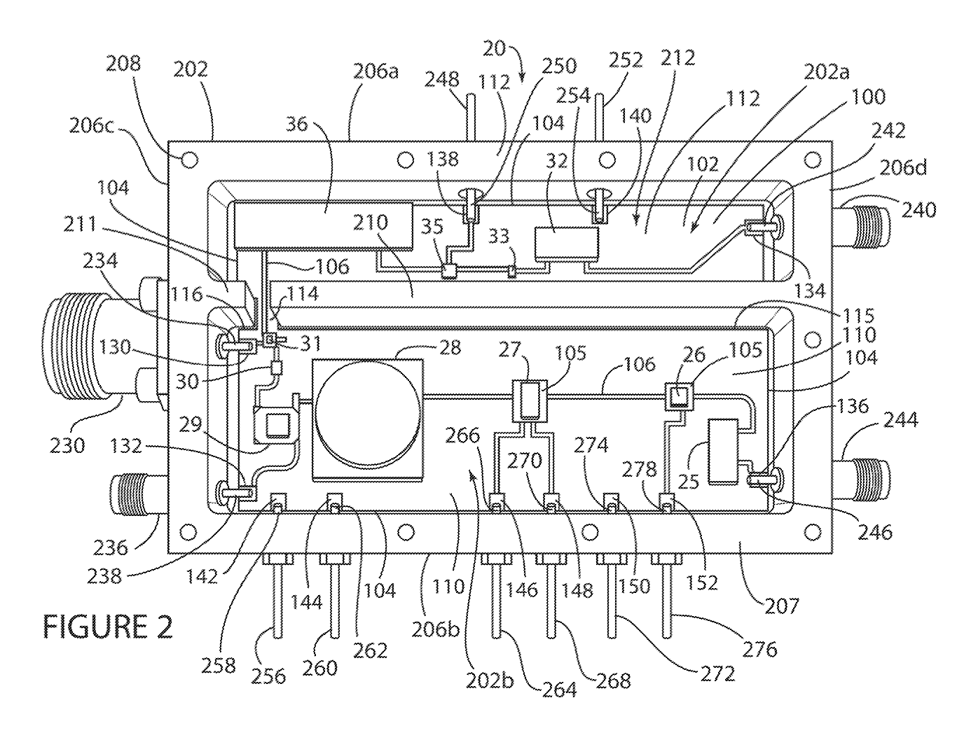

FIG. 1 is a block diagram of one embodiment of the electronic circuit board or substrate assembly, generally designated 100, of a time division duplex (TDD) WiMax front end module, generally designated 20 in FIG. 2, constructed in accordance with the present invention and adapted for use in connection with a wireless base station including, for example, the front end of a WiMax picocell.

As described in more detail below, the board assembly 100 has a transmitter circuit 21 and a receiver circuit 24.

Transmitter circuit 21 includes at least the following discrete, direct surface mountable electronic components: a transmit bandpass filter (Tx BPF) 25, a pre-amplifier/driver amplifier 26, a power amplifier (PA) 27, an isolator 28, a coupler 29, a low pass filter (LPF) 30, and a RF switch 31. The transmit bandpass filter 25 is connected to and in communication with pre-amplifier/driver 26. Pre-amplifier/driver amplifier 26 is connected to and in communication with the power amplifier 27. Power amplifier 27 is connected to and in communication with the isolator 28. Isolator 28 is connected to and in communication with the coupler 29. The coupler 29 is connected to and in communication with the low pass filter 30. The low pass filter 30 is connected to and in communication with the RF switch 31. RF switch 31 is adapted to be connected to and in communication with an antenna terminal 230, 234 that is connected to an antenna (not shown).

Receiver circuit 24 includes at least the following discrete, direct surface mountable (FIGS. 1 and 2) electronic components: a receive bandpass filter (Rx BPF) 32, a low pass filter (LPF) 33, a low noise amplifier (LNA) 35, another receive bandpass filter (Rx BPF) 36, and the RF switch 31. The RF switch 31 is connected to and in communication with the bandpass filter 36. Bandpass filter 36 is connected to and in communication with the low noise amplifier 35. Low noise amplifier 35 is connected to and in communication with the low pass filter 33. Low pass filter 33 is connected to and in communication with receive bandpass filter 32.

RF switch 31 is adapted to switch the connection to the antenna between the transmitter circuit 21 and the receiver circuit 24 such that only one of either the transmitter circuit 21 or the receiver circuit 24 is connected to the antenna at any one time.

With reference to FIGS. 1 and 2, it is understood that the module 20 includes a transmit signal input (Tx I/P) connector/terminal 244, 246 which is adapted for coupling at one end to a transmit port (not shown) of a picocell and to the bandpass filter 25 at the other end. Transmit signal input terminal 244, 246 is adapted to receive a transmit input signal from another circuit on the picocell that is desired to be transmitted.

A receive output signal (Rx O/P) connector/terminal 240, 242 is adapted to be coupled at one end to a corresponding receive signal port (not shown) of a picocell and to the receive bandpass filter 32 at the other end. Receive signal output connector/terminal 240, 242 is adapted to provide a receive output signal to a picocell.

Power amplifier supply voltage (VPA) is adapted to be supplied to amplifiers 26 and 27 through respective terminals or pins 276 and 264. A power amplifier bias voltage (PA Bias) is adapted to be supplied at a terminal 268 that is coupled to power amplifier 27. A portion of the transmit signal is sampled by coupler 29 and provided to a power detect terminal or pin 238.

A low noise amplifier supply voltage (VLNA) is adapted to be supplied to low noise amplifier 35 in receiver circuit 24 via a terminal or pin 248.

Substrate/board assembly 100 (FIGS. 1 and 2) is, in the embodiment shown, preferably made of GETEK®, FR408, or the like dielectric material and is about 0.75 mm (i.e., 0.029 inches) in thickness. The board 100 has an upper surface 102, a lower surface (now shown), and an outer peripheral circumferential edge 104. Predetermined regions of both the upper and lower surfaces of the board 100 are covered with copper pads 105, copper circuit lines 106, and solder mask material (not shown), all of which have been applied thereto and/or selectively removed therefrom as is known in the art to create the desired copper, dielectric, and solder mask regions and electrical circuits which interconnect the various electrical components. The metallization system is preferably ENIG, electroless nickel/immersion gold over copper.

A pair of elongated co-linear, longitudinally extending slots 115 and 116 are formed in board 100. A bridge 114 separates slots 115 and 116. Slot 115 splits the board 100 into a lower elongate, longitudinally extending transmit circuit board portion or region or plate 110 and an upper elongate, longitudinally extending receive circuit board portion or region 112 which is spaced from and parallel to the plate 110. Bridge 114 connects transmit circuit board portion or region 110 and receive circuit board portion or region 112. The components 25, 26, 27, 28, 29, and 30 of transmitter circuit 21 are located on the plate 110. The components 32, 33, 35, and 36 of receiver circuit 24 are located on the plate 112. In the embodiment shown, the switch 31 is located on the plate 110 and a circuit line 106 is formed on the bridge 114 and connects the switch 31 to the receive bandpass filter 36.

Although not described in any detail, it is understood that, in one embodiment, board 100 is comprised of a DC/RF layer on the upper surface 102 and a ground layer on the lower surface (not shown). In addition, any DC traces on the bottom surface require grooves in the floor of the housing of the module to avoid shorting. No solder mask is present on the lower surface of the board 100. The ground connection extends from the lower surface of the board 100 to the housing 202 (FIG. 2) which connects to the ground of the RF and DC connectors.

Board 100 has several input/output pads (FIG. 2) which are formed on the top surface 103 and extend along peripheral edge 104. Antenna pad 130 and power detect pad 132 are located along the left side transverse edge 104 of the plate 110 of board 100 in a spaced-apart and co-linear relationship. Receive pad 134 and transmit pad 136 are located along the right side transverse edge 104 of the respective plates 112 and 110 of board 100 in a spaced-apart and co-linear relationship. Low noise amplifier voltage supply (VLNA) pad 138 and ground pad 140 are located along the top side longitudinal edge 104 of the plate 112 of board 100 in a spaced-apart and co-linear relationship. First switch control pad 142, second switch control pad 144, amplifier voltage supply (VPA) pad 146, power down voltage pad 148, ground pad 150 and power amplifier bias voltage pad 152 are all located along the bottom side longitudinal edge 104 of the plate 110 of board 100 in a spaced-apart and co-linear relationship. Integrated circuit RF switch 31 is generally located on the plate 110 below bridge 114 and adjacent to antenna pad 130. Low pass filter 30 is located adjacent to left side transverse board edge 104 below the switch 31. Coupler 29 is generally located adjacent to left side transverse board edge 104 below the low pass filter 30 and above power detect pad 132. Isolator 28 is located above pad 144 and adjacent and to the right of the coupler 29. Power amplifier 27 is generally centrally located on plate 110. Pre-amplifier 26 is located on plate 110 toward the right side transverse board edge 104 in a co-linear relationship with amplifier 27. Transmit band pass filter 25 is located on plate 110 toward the right side transverse board edge 104 below pre-amplifier/driver amplifier 26 and to the right of pad 152.

RF switch 31, low pass filter 30, coupler 29, isolator 28, power amplifier 27, pre-amplifier 26 and transmit band pass filter 25 are all commercially available discrete, direct surface mountable electronic components. In the embodiment shown, circuit lines 106 couple pad 130 to switch 31; switch 31 to low pass filter 30; low pass filter 30 to coupler 29; pad 132 to coupler 29; coupler 29 to isolator 28; isolator 28 to amplifier 27; pads 146 and 148 to amplifier 27; amplifier 27 to pre-amplifier 26; pad 152 to pre-amplifier 26; pre-amplifier 26 to filter 25; and filter 25 to pad 136.

Although not shown, it is understood that appropriate resistors, capacitors, and inductors are all generally located and fixed on the top surface 102 of board 100 around coupler 29, isolator 28, amplifier 27, pre-amplifier 26, and transmit bandpass filter 25 for performing decoupling, filtering, and biasing functions as known in the art.

As described above, receive section or plate 112 of circuit board 100 includes several electronic components mounted to the top surface 102 and interconnected by circuit lines 106. Receive band pass filter 36 is generally located on plate 112 above bridge 114 and below top longitudinal board edge 104. Low noise amplifier 35 is generally located on plate 112 toward the center of receive section or plate 112 to the right of band pass filter 36 and above slot 115. Low pass filter 33 is generally centrally located on plate 112 to the right of, and co-linearly with low noise amplifier 35 and above slot 115. Receive band pass filter 32 is located on plate 112 to the right of low pass filter 33 and above slot 115.

Receive band pass filter 36, low noise amplifier 35, low pass filter 33 and receive band pass filter 32 are also all commercially available discrete, direct surface mountable electronic components.

In the embodiment shown, circuit lines 106 couple the switch 31 to filter 36; filter 36 to amplifier 35; amplifier 35 to filter 33; pad 138 to the circuit line bridging amplifier 35 and filter 33; filter 33 to filter 32; and filter 32 to pad 134. Although not shown, it is understood that appropriate capacitors and inductors are coupled to filter 36, amplifier 35, filter 33, and filter 32 for performing decoupling, filtering, and biasing functions as known in the art.

One structural embodiment of a time division duplex front end module 20 according to the invention is shown in FIG. 2 and includes a housing 202, the printed circuit board assembly 100 shown in FIG. 1, a cover or lid (not shown), and several connectors and terminals as described in more detail below.

Housing 202 is generally rectangular in shape and is defined by four upstanding peripheral walls 206a, 206b, 206c, and 206d that extend perpendicularly upwardly from a planar bottom surface or floor (not shown). Walls 206a and 206b define longitudinally extending walls while walls 206c and 206d define transversely extending walls. A circumferential flat rim 207 is defined at the top of walls 206. Walls 206 together define an interior housing cavity 212. Several threaded bores 208 extend downwardly from rim 207 into walls 206 and are adapted to receive screws or the like (not shown) for securing a lid (not shown) to the housing 202.

Housing 202 further includes interior cavity walls 210 and 211 extending perpendicularly upwardly from the bottom surface or floor (not shown). Wall 210 extends across approximately 90% of the length of cavity 212 and wall 211 extends across approximately 5% of the length of cavity 212. Walls 210 and 211 are co-linearly aligned and extend in a direction parallel to, and spaced from, longitudinal housing walls 206a and 206b and separate housing 202 into an upper receiver circuit housing section 202a and a lower transmitter circuit housing section 202b to improve Tx/Rx isolation.

Housing 202 and the cover (not shown) can be machined from a metal such as aluminum. Housing 202 can act as an RF shield to contain and block electromagnetic fields and can also serve as a heat sink to dissipate heat away from components that generate substantial amount of heat energy such as power amplifier 26.

Several apertures (not shown) are formed in walls 206 to facilitate electrical connections into cavity 212.

An antenna connector 230 is mounted to housing 202 and includes a terminal 234 which extends through one of the apertures (not shown) and into the transmitter section 202b of cavity 212. An antenna cable (not shown) is adapted to be connected to connector 230.

A power detect connector 236 is mounted to housing 220 and includes a terminal 238 which extends through another of the apertures (not shown) in transverse wall 206C into the transmitter section 202b of cavity 212. In the embodiment shown, the connectors 230 and 236 are disposed in a spaced-apart and parallel relationship.

A receive signal connector 240 is mounted to housing 202 and includes a terminal 242 which extends through yet another of the apertures (not shown) in transverse wall 206d into the receiver section 202a of cavity 212. Connector 240 is adapted to be connected with a receiver circuit on a picocell or microcell.

A transmit signal connector 244 is mounted to housing 202 and likewise includes a terminal 246 which extends through one of the apertures (not shown) in transverse wall 206d into cavity 212: Connector 244 is adapted to be connected with a transmitter circuit on a picocell or microcell. In the embodiment shown, the connectors 244 and 246 are disposed in a spaced-apart and parallel relationship.

A low noise amplifier voltage supply (VLNA) terminal 248 is mounted to housing 202 and extends through one of apertures (not shown) in longitudinal wall 206a into receiver section 202a of cavity 212. Terminal 248 has an interior terminal end 250.

Ground terminal 252 is mounted to housing 202 and extends through one of the apertures (not shown) in longitudinal wall 206a into receiver section 202a of cavity 212. Terminal 252 has an interior terminal end 254. In the embodiment shown, the terminals 248 and 256 are disposed in a spaced-apart and parallel relationship.

A first switch control terminal 256 is mounted to housing 202 and extends through one of the apertures (not shown) in longitudinal wall 206b into cavity 212. Terminal 256 has an interior terminal end 258. A second switch control terminal 260 is mounted to housing 202 and extends through one of the apertures (not shown) in longitudinal wall 206b into cavity 212. Terminal 260 has an interior terminal end 262.

Amplifier voltage supply (VPA) terminal 264 is mounted to housing 202 and extends through one of the apertures (not shown) in longitudinal wall 206b into cavity 212. Terminal 264 has an interior terminal end 266.

PA Bias voltage terminal 268 is mounted to housing 202 and extends through one of the apertures (not shown) in longitudinal wall 206b into cavity 212. Terminal 268 has an interior terminal end 270.

Another ground terminal 272 is mounted to housing 202 and extends through one of the apertures (not shown) in longitudinal wall 206b into cavity 212. Terminal 272 has an interior terminal end 274. Driver amplifier voltage terminal 276 is mounted to housing 202 and extends through one of the apertures (not shown) in longitudinal wall 206b into cavity 212. Terminal 276 has an interior end 278.

In the embodiment shown, terminals 256, 260, 264, 268, 272, and 276 are all disposed in a spaced-apart and parallel relationship.

Housing assembly 202 can be mounted to a heat sink (not shown) in a microcell or picocell. Coaxial cables (not shown) would be connected with coaxial connectors 230, 236, 240 and 244 in order to facilitate electrical communication between the module 20 and the microcell or picocell.

Module 20 of the present invention as depicted in FIG. 2 may, in one embodiment, measure less than 60.0 mm. in width, 90.0 mm. in length, and 28.0 mm. in height. In another embodiment, module 20 may be larger than 60.0 mm. in width, 90.0 mm. in length, and 28.0 mm. in height. In additional embodiments, module 20 may have various shapes other than rectangular.

Printed circuit board assembly 100 is seated and secured into cavity 212 of housing 202 with transmit section or plate 110 mounted in transmit housing section 202b; receive section or plate 112 mounted in receive housing section 202a; and housing walls 210 and 211 extending through respective board slots 115 and 116 to separate and isolate the respective transmit and receive sections of the circuit board assembly 100.

The interior terminal ends of each of the respective connectors 230, 236, 240, and 244 and terminals 248, 252, 256, 260, 264, 268, 272, and 276 are soldered to the respective pads 130, 132, 134, 136, 138, 140, 142, 144, 146, 148, 150, and 152 on the top surface 103 of printed circuit board assembly 100 during the assembly process.

Thus, module 20 and associated board assembly 100 is adapted to replace all of the discrete RF components that would be typically individually mounted and used in a WiMax front end. Module 20 allows customers to select different values for receiver sensitivity, selectivity, and output power. Module 20 can be RoHS compliant and lead-free.

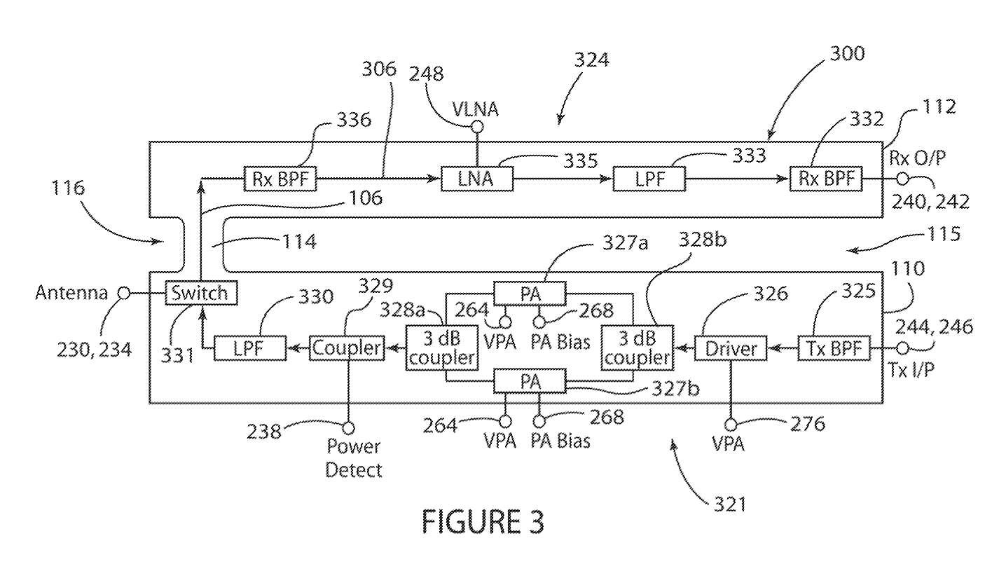

FIG. 3 is a block diagram of another substrate/printed circuit board embodiment 300 constructed in accordance with the present invention and adapted for use in the housing 202 shown in FIG. 2.

As described in more detail below, the board assembly 300 has a transmitter circuit 321 and a receiver circuit 324.

Transmitter circuit 321 includes at least the following discrete, direct surface mountable, electronic components: a transmit bandpass filter (Tx BPF) 325, a pre-amplifier/driver 326, a pair of power amplifiers (PA) 327a and 327b, a pair of 3 dB couplers 328a and 328b, another coupler 329, a low pass filter (LPF) 330, and an RF switch 331. The transmit bandpass filter 325 is connected to and in communication with the pre-amplifier/driver 326. The pre-amplifier/driver amplifier 326 is connected to and in communication with the 3 dB coupler 328b. The 3 dB coupler 328b, in turn, is coupled to both of the power amplifiers 327a. and 327b which, in turn, are both coupled to the second 3 dB coupler 328a. 3 dB coupler 328a is connected to and in communication with coupler 329. Coupler 329 in turn is connected to and in communication with the low pass filter 330.

Low pass filter 330 is connected to and in communication with the RF switch 331. RF switch 331 is connected to and in communication with the antenna connector/terminal 230, 234 of module 20.

Receiver circuit 324 includes at least the following discrete, direct surface mountable, electronic components: a receive bandpass filter (Rx BPF) 332, a low pass filter (LPF) 333, a low noise amplifier (LNA) 335, another receive bandpass filter (Rx BPF) 336, and the RF switch 331. The RF switch 331 is connected to and in communication with the bandpass filter 336. The bandpass filter 336 is connected to and in communication with the low noise amplifier 335. Low noise amplifier 335 is connected to and in communication with the low pass filter 333. Low pass filter 333 is connected to and in communication with the bandpass filter 332.

The board assembly 300, in the same manner as the board assembly 100, may also include other appropriate RF components of the discrete surface-mountable type and is adapted to replace all of the discrete RF components that would be typically individually mounted and used in a WiMax front end.

Although not shown or described in any detail, it is understood that the board assembly 300 is adapted to be seated and mounted in the housing 202 of module 20 shown in FIG. 2 in the same manner as the board assembly 100 shown in FIGS. 1 and 2, and thus the description above with respect to the board assembly 100 is incorporated by reference with respect to the board assembly 300.

Moreover, and referring to FIGS. 2 and 3, it is understood that the transmit signal input connector/terminal 244, 246 of module 20 is adapted to be coupled at one end to a transmit port (not shown) of a picocell and to the transmit bandpass filter 325 on board assembly 300 at the other end. Receive output signal connector/terminal 240, 242 is adapted to be coupled at one end to a corresponding receive signal port (not shown) of a picocell and to the receive bandpass filter 332 on board assembly 300 at the other end.

Power amplifier supply voltage (VPA) is adapted to be supplied to amplifiers 326, 327a, and 327b through terminals or pins 264 and 276. A power amplifier bias voltage (PA Bias) is adapted to be measured at terminal 268 that is coupled to respective power amplifiers 327a and 327b. A portion of the transmit signal is sampled by the coupler 329 and provided to the power detect terminal 238. A low noise amplifier supply voltage (VLNA) is adapted to be supplied to low noise amplifier 335 through the terminal 248.

While the invention has been taught with specific reference to two embodiments of the module adapted for use on the front end of a picocell, it is understood that someone skilled in the art will recognize that changes can be made in form and detail such as, for example, to the selection, number, placement, interconnection values, and patterns of the various RF elements and circuits, without departing from the spirit and the scope of the invention as defined in the appended claims. The described embodiments are to be considered in all respects only as illustrative of two embodiments and not restrictive.

What is claimed is:

1. An electronic assembly comprising:
a housing defining a cavity;
a substrate located in the cavity;
a first section on the substrate defining a transmit path for a transmit signal and including at least the following components mounted thereon: a bandpass filter, a power amplifier, and a coupler;
a second section on the substrate defining a receive path for a receive signal and including at least the following electrical components mounted thereon: a receive bandpass filter and a low-noise amplifier; and
a switch between and interconnecting the respective first and second sections to an antenna terminal.

2. The electronic assembly of claim 1 wherein the substrate defines a slot and the housing includes an interior wall, the interior wall in the housing extending through the slot in the substrate.

3. The electronic assembly of claim 1 wherein the first section further comprises a pre-amplifier between the bandpass filter and the power amplifier and the second section further comprises a second receive bandpass filter.

4. The electronic assembly of claim 3 wherein the first section further comprises an isolator between the power amplifier and the coupler and the receive section further comprises a low pass filter between the low-noise amplifier and the second receive bandpass filter.

5. The electronic assembly of claim 1 wherein the first section comprises first and second power amplifiers and first and second couplers between the bandpass filter and the coupler.

6. An electronic assembly comprising:
a transmitter circuit adapted to receive a transmit input signal and generate a transmit output signal including at least the following discrete components:
a first bandpass filter in communication with a first amplifier;
a first coupler in communication with the first amplifier;
a switch in communication with the coupler, the switch being connected to an antenna terminal;
a receiver circuit adapted to receive a receive input signal and generate a receive output signal including at least the following discrete components:
a second bandpass filter in communication with the switch;
a second amplifier in communication with the second bandpass filter;
a third bandpass filter in communication with the second amplifier; and
the elements of the transmitter and receiver circuits being direct surface mounted on a substrate which is mounted on the front end of a base station.

7. The electronic assembly of claim 6 wherein the substrate is mounted in a housing including a peripheral exterior wall and an interior wall, the substrate including first and second sections separated by a slot, the transmitter and receiver circuits being formed on the first and second sections respectively, the interior wall protruding through the slot in the substrate and isolating the transmitter and receiver circuits.

8. The electronic assembly of claim 6 wherein the substrate is seated in a housing defining a peripheral wall and a plurality of terminals extend into the housing through the peripheral wall and into contact with the substrate.

9. The electronic assembly of claim 6 wherein the transmitter circuit further comprises an isolator between the power amplifier and the coupler.

10. The electronic assembly of claim 6 wherein the second amplifier in the first section comprises a pair of amplifiers connected to second and third couplers.

11. An electronic front end module comprising:
a housing including an exterior peripheral wall defining an interior cavity;
a substrate seated in the cavity in the housing and including first and second sections;
a plurality of electronic components mounted on the first section and defining an RF signal transmit path;
a plurality of electronic components mounted on the second section and defining an RF signal receive path;
a switch in the housing and interconnecting the electronic elements mounted on the first and second sections of the substrate; and
a plurality of terminals extending through the exterior peripheral wall of the housing into contact with the substrate.

12. The electronic front end module of claim 11 wherein the substrate defines a slot which separates the first and second sections and a bridge on the substrate couples the first and second sections, the housing including an interior wall extending through the slot and isolating the first and second sections of the substrate.

13. The electronic front end module of claim 12 wherein at least the following discrete electronic components are direct surface mounted on the first section of the substrate: a bandpass filter, a driver, a power amplifier, and a first coupler connected to the switch.

14. The electronic front end module of claim 13 wherein the power amplifier comprises a pair of separate amplifiers coupled to the driver and further comprising second and third couplers coupled to the pair of amplifiers respectively, the third coupler being coupled to the first coupler.

15. The electronic front end module of claim 12 wherein at least the following discrete electronic components are direct surface mounted on the second section of the substrate: first and second bandpass filters and a low noise amplifier.
